(19) United States
(12) Patent Application Publication
(10) Pub. No.: US 2009/0015978 A1
(43) Pub. Date: Jan. 15, 2009

(54) Non-inductive silicon transient voltage suppressor

(76) Inventor: O. Melville Clark, Tempe, AZ (US)

Correspondence Address: Michael A. Sileo, Jr.;Microsemi Corporation, Suite 900, 740 E. Campbell Road, Richardson, TX, 75081, US

(21) Appl. No.: 11/827,470

(22) Filed: Jul. 12, 2007

(51) Int. Cl. H02H 3/22

(52) U.S. Cl. 361/111

(57) ABSTRACT

A transient voltage suppressor (TVS) with virtually no inductance in a shunt current path, thus providing optimal fast-rise transient voltage spike protection. A planar thru-conductor is operably coupled to the entire length of a cathode side surface of a TVS chip thereby reducing the inductance through the TVS chip to ground. The virtually zero inductance through the shunt current path allows the TVS chip to effectively limit fast-rise transient voltage spikes to safe levels, and prevents generating leak-thru energy that could cause a latch-up condition or destructive effects. Provision is made to suppress long duration transient pulses is available through affixing the TVS to a larger thermal mass providing the necessary heat sinking to absorb the additional power dissipated during these events.

### FIELD OF THE INVENTION

The present invention is generally related to transient voltage suppressors (TVSs), and more specifically to non-inductive silicon TVSs.

### BACKGROUND OF THE INVENTION

Silicon transient voltage suppressors (TVSs) are clamping devices that limit voltage spikes by providing a low impedance avalanche breakdown of a rugged silicon pn junction placed between the incident voltage spike and the electrically vulnerable component. TVSs are used to protect sensitive components from electrical overstress, such as that caused by induced lightning, inductive load switching and electrostatic discharge.

When a transient voltage appears, the TVS becomes active, immediately, limiting the spike voltage to a safe level while diverting damaging currents away from the protected circuit. TVS electrical parameters, such as breakdown voltage, leakage current, and capacitance are selected to be “invisible” to the circuit being protected and have no effect on the circuit performance. The reverse standoff voltage, which approximates the circuit operating voltage, is normally 10% below breakdown voltage. This assures minimal standby leakage current and compensates for voltage excursions caused by temperature variations.

Present TVSs used in the marketplace are attached in such a manner that the shunt path through the transient voltage suppressor (TVS) contains a quantity of inductance in the terminations per Michael Faraday's Laws of Induction, V=−L(di/dt), increasing “leak-thru” energy, in some instances, above the limits of the design of the protected component. The nanosecond rise of Electrostatic Discharge (ESD) at low currents or a moderate rise time of a high current in the hundreds of amperes undesirably develops an undesirable high voltage drop across the inductance in the shunt current path as illustrated in FIGS. 1A, 1B, and 1C.

In each of the devices shown in FIGS. 1A, 1B, and 1C, there is a finite amount of inductance, even with the shortest shunt path. Typical performance of such devices are illustrated in FIGS. 2A, 2B, and 2C, where an incident voltage spike approaches a TVS and results in a “leak-thru” voltage, the value of which varies based on the terminal inductance. For fast rise times of ESD, “leak-thru” voltages past the TVS in excess of 200 V have been observed. The lower the inductance, the lesser the −L(di/dt) effects in limiting the magnitude of a voltage spike, resulting in a small “leak-thru” voltage, as shown in FIG. 2C. The larger the terminal inductance, the greater the −L(di/dt) effects resulting in a higher “leak-thru” voltage, as shown in FIG. 2A.

As observed in FIGS. 2A, 2B, and 2C, there is reduced “leak-thru” energy as the inductance of the shunt current path is reduced. The axial lead configuration shown in FIG. 1A has the greatest leak-through energy of the three devices, as it has the highest inductive shunt current path. The one terminal, single tab mount configuration shown in FIG. 1C provides the lowest “leak-thru” energy of the three devices. Perceived as benign, small “leak-thru” energy spikes can damage components or trigger sensitive I/O ports into latch-up conditions through phantom silicon controlled rectifiers (SCRs) inherent in I/O port circuitry.

Standard surface mount TVS devices may be adequate for today's transmitter/receiver chips but may not be adequate for smaller geometries. On-chip components are exceedingly small and continue to downsize. Present components are built on line-widths of approximately 1 micron with new production downsizing to 0.6 to 0.75 microns, the smaller components being more vulnerable to ESD threats. Improved protection will also reduce latent failures which have been reviewed extensively in the EOS/ESD seminar proceedings over the past years. New applications for very high currents appear in RTCA/DO-160E for severe lightning protection, mostly for AC and DC power distribution and equipment in poorly shielded areas of aircraft composite structure. Maximum surge currents are 1600A.

There is, therefore, desired a TVS which has its inductive path reduced to virtually zero, and negates any self-inductive effects of a single conductor.

### SUMMARY OF INVENTION

The present invention achieves technical advantages as a silicon transient voltage suppressor (TVS) having virtually no inductance in the shunt current path, thus providing optimal fast-rise transient voltage spike protection. One embodiment of the invention utilizes a planar thru-conductor operably coupled to the entire length of a cathode (anode or bidirectional) side of a TVS chip thereby virtually eliminating an inductive path through the TVS terminations to ground. The virtually zero induction through the shunt current path allows the TVS chip to effectively limit fast-rise transient voltage spikes to safe levels, also very high current transient voltages at moderately fast rise-times, of the order of microseconds, to safe levels. Additionally, the TVS may be a bi-directional silicon chip which is a silicon chip with a pn junction on both top and bottom surfaces, a single silicon p-n junction on one surface only, a plural of chips or other element or elements of equivalent function.

### BRIEF DESCRIPTION OF THE DRAWINGS

FIGS. 1A-1C are illustrations showing the relative amounts of inductive content across the shunt current path of three different prior art devices;

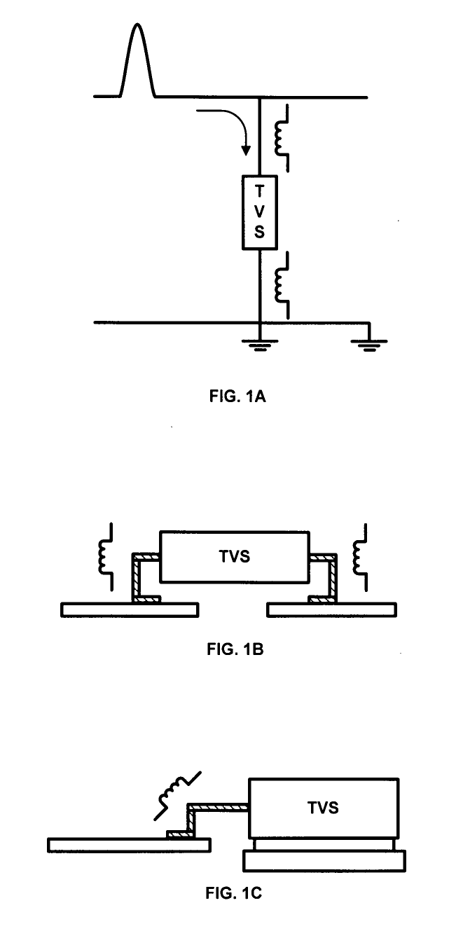

FIGS. 2A-2C are illustrations showing the relative effects on “leak-thru” voltage resulting from inductive content in the devices of FIGS. 1A-1C; and

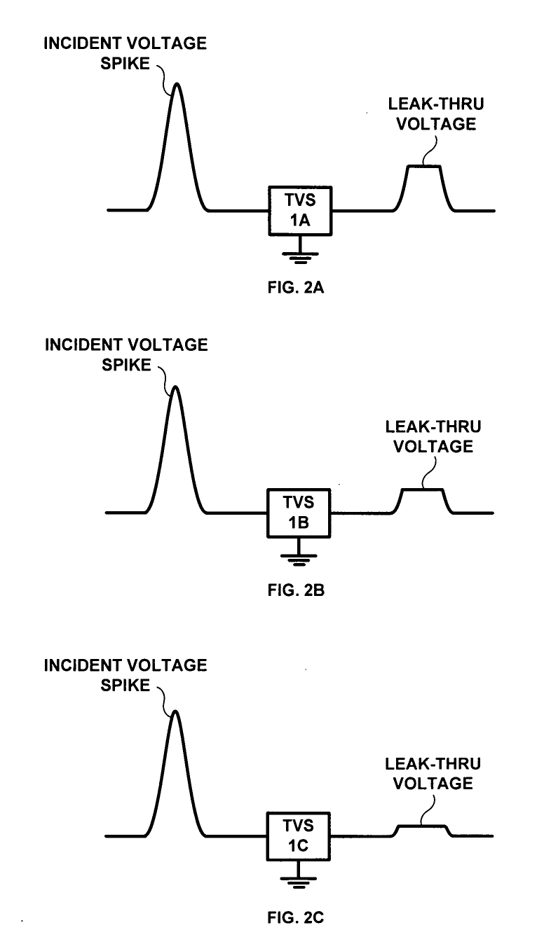

FIG. 3 is a diagram of a non-inductive transient voltage suppressor performing in accordance with an exemplary embodiment of the present invention.

### DETAILED DESCRIPTION OF THE INVENTION

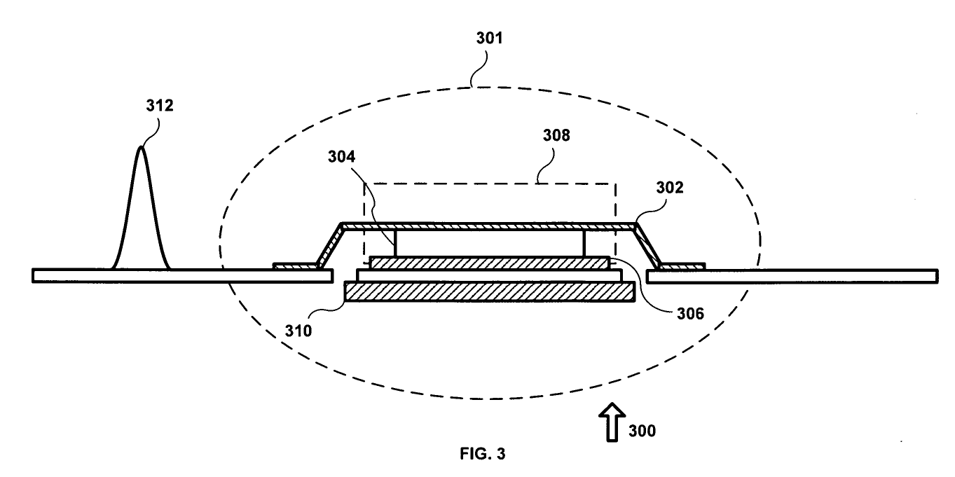

Referring to FIG. 3, there is shown at 300 a diagram of a non-inductive silicon transient voltage suppressor (TVS) performing in accordance with an exemplary embodiment of the present invention. Advantageously, non-inductive silicon TVS 301 provides protection to sensitive circuitry by virtually eliminating the inductance of the shunt current path, which allows non-inductive silicon TVS 301 to react immediately to clamp the voltage of fast-rise transient voltage spike 312. Non-inductive silicon TVS 301 is comprised of planar thru-conductor 302, TVS chip 304, base 306, and surface mount package 308.

Planar thru-conductor 302 has an input tab on a first end and an output tab on a second opposing end, a flat top side surface and a flat bottom side surface. TVS chip 304 is a semiconductor junction pulse suppressor having a flat cathode side surface parallel to a flat anode side surface. Base 306 can be made of metal, metal alloy, or any other highly-conductive material. Surface mount package 308 can be made of plastic, ceramic, or any other non-conductive material.

The anode side surface of TVS chip 304 is operably coupled to base 310. TVS chip 308 can be operably coupled to base 310 with conventional soldering or die bonding techniques. The flat bottom side surface of planar thru-conductor 302 is disposed onto TVS chip 304 so that planar thru-conductor 302 and TVS chip 304 are parallel. The bottom side surface of planar thru-conductor 302 is operably coupled to the entire length of the cathode side surface of TVS chip 304 with conventional soldering or die bonding techniques.

Package 308 is molded around planar thru-conductor 302, TVS chip 304, and base 306, so that base 306, TVS chip 304, and a portion of planar thru-conductor 302 that is operably coupled to TVS chip 304, are encapsulated. The input tab, and the length of the first end of planar thru-conductor 302 required to clear the combined height of TVS chip 304 and base 306 from the input tab, are left exposed on one side of package 308. The output tab, and the length of the second end of planar thru-conductor 302 required to descend from the combined height of TVS chip 304 and base 306 down to the output tab are left exposed on the side opposite the input tab of package 308. The techniques for packaging semiconductors are well known in the semiconductor industry, and as such, do not require a more detailed explanation.

In operation, fast-rise transient voltage spike 312 propagates along an electrical trace in a circuit board toward sensitive circuitry protected by the non-inductive silicon TVS 301. Fast-rise transient voltage spike 312 propagates from the electrical trace to the input tab of planar thru-conductor 302 and on toward TVS chip 304. Advantageously, due to the flat surface coupling of thru-conductor 302 with TVS chip 304, there is virtually no inductance between the two elements. This near zero inductive path through TVS chip 304 virtually negates any self-inductive effects of single thru-conductor 302, and any “leak-thru” energy.

Once fast-rise transient voltage spike 312 encounters the point where planar thru-conductor 302 is operably coupled to TVS chip 304, fast-rise transient voltage spike 312 has a current that is effectively channeled to ground through TVS chip 304, which becomes a shunt current path. Because there is virtually no inductance through the shunt current path to slow the reaction time of TVS chip 304 to fast-rise transient voltage spike 312, any induced voltage supplied to the sensitive circuitry is effectively limited to, for all practical purposes, a zero value above the normal clamping voltage level of the TVS during fast-rise transient voltage spike 312.

TVS 301 effectively eliminates problems arising from ESD, which are lethal to most semiconductor circuits, especially transmit-receive signal components. Furthermore, large discrete silicon TVSs for power distribution applications can be made with sufficiently heavy thru-conductors to carry the circuit current, and can be constructed with thru-holes for screw attach terminals if desired. TVS devices are normally designed and used for short term transient spikes having time durations in the hundreds of microsecond range with a maximum of 1000 microseconds.

In a second exemplary embodiment, due to the large flat surface of base 306 of this configuration, for higher power components a large thermal mass (heat-sink) 310 can be attached to extend the capability for transient pulse widths up to 50 milliseconds or more.

The present invention derives technical advantages because first, other solutions can't suppress the shunt path inductance to virtually zero. Although today's TVSs are being made with low inductive surge paths, there is still a problematic inductance associated with the surge path through the voltage suppressing chip. The present invention achieves further technical advantages by having no overshoot voltage or “leak-thru” energy for sensitive circuitry, therefore reducing I/O ports from being triggered into latch-up conditions and any damaging effects to down-stream circuitry.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

What is claimed is:

1. A non-inductive Transient Voltage Suppressor, comprising:
a silicon chip having a cathode side surface and an anode side surface adapted to provide transient voltage spike protection;
a planar thru-conductor having a top side surface, a bottom side surface, a first end, and a second end, wherein the bottom side surface of the planar thru-conductor is operably coupled to the entire length of the cathode side surface of the silicon chip, and the planar thru-conductor is adapted to substantially eliminate inductance between the cathode side surface of the silicon chip and the bottom side surface of the planar thru-conductor;
an electrically conductive base operably coupled to the anode side surface of the silicon chip; and
wherein the silicon chip, the planar thru-conductor, and the base are disposed within a surface mount package with the first end and the second end of the planar thru-conductor extending outwardly from the surface mount package.

2. The non-inductive Transient Voltage Suppressor of claim 1, wherein the silicon chip contains a silicon p-n junction or other element of equivalent function.

3. The non-inductive Transient Voltage Suppressor of claim 1, wherein the surface mount package is made of non-conducting material.

4. The non-inductive Transient Voltage Suppressor of claim 1, wherein the base electrode of the device is affixed to a large thermal mass.

5. A non-inductive Transient Voltage Suppressor, comprising:
a silicon chip having a cathode side surface and an anode side surface adapted to provide transient voltage spike protection;
a planar thru-conductor having a top side surface, a bottom side surface, a first end, and a second end, wherein the bottom side surface of the planar thru-conductor is operably coupled to the entire length of the anode side surface of the silicon chip, and the planar thru-conductor is adapted to substantially eliminate inductance between the anode side surface of the silicon chip and the bottom side surface of the planar thru-conductor;
an electrically conductive base operably coupled to the cathode side surface of the silicon chip; and
wherein the silicon chip, the planar thru-conductor, and the base are disposed within a surface mount package with the first end and the second end of the planar thru-conductor extending outwardly from the surface mount package.

6. The non-inductive Transient Voltage Suppressor of claim 5, wherein the silicon chip contains a silicon p-n junction or other element of equivalent function.

7. The non-inductive Transient Voltage Suppressor of claim 5, wherein the surface mount package is made of a non-conducting material.

8. The non-inductive Transient Voltage Suppressor of claim 5, wherein the base electrode of the device is affixed to a large thermal mass.

9. A non-inductive Transient Voltage Suppressor, comprising:
a bi-directional silicon chip having a first side surface and a second side surface adapted to provide transient voltage spike protection;
a planar thru-conductor having a top side surface, a bottom side surface, a first end, and a second end, wherein the bottom side surface of the planar thru-conductor is operably coupled to the entire length of the first side surface of the silicon chip, and the planar thru-conductor is adapted to substantially eliminate inductance between the first side surface of the bi-directional silicon chip and the bottom side surface of the planar thru-conductor;
an electrically conductive base operably coupled to the second side surface of the silicon chip; and
wherein the silicon chip, the planar thru-conductor, and the base are disposed within a surface mount package with the first end and the second end of the planar thru-conductor extending outwardly from the surface mount package.

10. The non-inductive Transient Voltage Suppressor of claim 9, wherein the silicon chip contains a bi-directional silicon p-n junction or other element of equivalent function.

11. The non-inductive Transient Voltage Suppressor of claim 9, wherein the surface mount package is made of a non-conducting material.

12. The non-inductive Transient Voltage Suppressor of claim 9, wherein the base electrode of the device is affixed to a large thermal mass.
